(19) United States
(12) Patent Application Publication
(10) Pub. No.: US 2014/0129123 A1
(43) Pub. Date: May 8, 2014

(54) Data Exchange Protocol to Enable Server-Based Traffic Related Alert Systems via Mobile Devices

(71) Applicant: Shahram Rezaei, Danville, CA (US)

(72) Inventor: Shahram Rezaei, Danville, CA (US)

(21) Appl. No.: 13/847,066

(22) Filed: Mar. 19, 2013

Related U.S. Application Data
(60) Provisional application No. 61/650,686, filed on May 23, 2012.
(60) Provisional application No. 61/647,168, filed on May 15, 2012.
(60) Provisional application No. 61/647,326, filed on May 15, 2012.

(51) Int. Cl. G08G 1/00

(52) U.S. Cl. CPC G08G 1/00
USPC 701/117; 701/1

(57) ABSTRACT

Object of the present invention is to provide a data exchange protocol to enable mobile device based alert systems to deliver traffic related alerts to drivers. The protocol is based on running first order Kinematic model for motion of vehicles on both Client and Server sides. Each Client only sends to the server minimum samples of the motion that are sufficient enough to keep lateral (perpendicular to moving direction of vehicle) and longitudinal (along moving direction of vehicle) position errors bounded. Position error here is defined as difference between original motion sample and sample derived from transmitted samples on the server.

### BACKGROUND OF THE INVENTION

1. Field of the Invention

The present invention relates to mobile devices that are equipped with positing unit (for example GPS) and capable of data communications. This invention is in particular related to delivering alerts to vehicle drivers via their mobile devices, such as smart phone and tablet, in order to notify them about traffic ahead.

2. Description of the Prior Art

In today's world, many people own and carry GPS-enabled mobile phones. Due to the e911 mandate, wireless carriers must be able to locate a 911 mobile-phone caller to within 50 to 300 meters of accuracy. Various technologies have been used to satisfy this mandate including embedded GPS hardware in mobile phones. The implementation of such positioning technologies has led to the creation of a class of software application known as Location-Based Services (LBS) that use the device's location in coordination with other data to create location-aware applications.

In-vehicle technologies and safety related systems are a growing area of research and product development. The use of in-vehicle safety technologies has been developing and growing for decades. Over the years, there have been numerous evaluations of ITS (Intelligent Transportation Systems) technologies for safety applications. For example, there have been a number of evaluations of the speed limiting and alerting technology known as Intelligent Speed Adaptation (ISA).

Slow traffic ahead alert systems falls under the category of Active Safety Systems. An active safety system is an in-vehicle system that provides warnings or other forms of assistance to drivers based on information about the motion of self vehicle and other vehicles, obtained from object detection sensors mounted on the vehicles. Active safety systems are divided into two classes: Hard and Soft. A hard active safety system is for fast reaction in the order of a few seconds (2-3 seconds or so) like safety system deployed on high-end cars such as Cadillac, BMW, Lexus, etc that warn drivers about lane departure, lane change blind spot, rear-end collision, etc. Soft active safety systems are situational-awareness functions that provide alerts to drivers on driving conditions within a relatively short-latency time horizon, in the range of 10-60 seconds. An example of these systems is a mobile-phone based slow traffic ahead alert system. Such a system enables drivers to take tactical actions to avoid crashes, or in essence, increase their safety alert time horizon to beyond the just several seconds provided by hard safety systems. In these situations, by offering a timely “slow or stopped traffic ahead” message, the system can effectively inform drivers of roadway hazards or give speed advisories to reduce the chance of collisions. This safety application is similar to a successful implementation of vehicle-infrastructure concept in Tokyo, Japan in recent years.

To enable a Mobile-phone based traffic ahead alert system, phone communicates with a server to exchange information. These data include but not limited to time, vehicle location, speed, moving direction, and similar information for downstream traffic.

### SUMMARY OF THE INVENTION

Object of the present invention is to provide a data exchange protocol to enable mobile device based traffic ahead alert systems. In this kind of alert system, a software application, Client, runs on the phone that exchanges data with one or more Servers. Data that are uploaded to the server(s) include but not limited to time, vehicle location, speed, and moving direction which are updated normally every second. Server sends to the Client location and speed of downstream traffic. Vehicle location changes rapidly at high speed, for example at 40 m/s (˜90 mph) vehicle travels 40 meters in just one second. Thus if motion of the vehicle is not modeled, Client should send to the server raw data sampled as fast as every second. The present invention presents a scheme that reduces the sampling rate significantly, at least 80%.

In one aspect, a method is provided of exchanging vehicle location information. At intervals, at one or more vehicles, sensor information is input including at least vehicle location information. An estimation process is performed for estimating at sub-intervals at least vehicle location to obtain estimated vehicle data. A subset of the vehicle data is selected and sent to a remote server. A client-side modeling process is performed for modeling at least vehicle location using the subset of vehicle data to obtain modeled vehicle data. The estimated vehicle data and the modeled vehicle data are compared to obtain comparison results. The comparison results are used to select the subset of vehicle data to be sent to the remote server. The vehicle may receive from the remote server other vehicle data for multiple other vehicles. At the vehicle, the other vehicle data may be used to model at least vehicle location for each of the multiple other vehicles. The vehicle may also receive from the remote server local traffic alert information. A server-side modeling process may be performed for modeling at least vehicle location using the subset of vehicle data to obtain modeled vehicle data, with the same model being used by both the client-side modeling process and the server-side modeling process. The foregoing steps may be performed at many different vehicles.

In another aspect, a system is provided for exchanging vehicle location information, including one or more servers; a communication network; and a plurality of in-vehicle systems carried by a plurality of vehicles. Each in-vehicle system includes one or more navigation sensors or receivers configured to, at intervals, output sensor information including at least vehicle location information. A processor is provided for performing an estimation process for estimating at sub-intervals at least vehicle location to obtain estimated vehicle data. The processor selects a subset of the vehicle data and sends the subset of vehicle data to a remote server. It also performs a client-side modeling process for modeling at least vehicle location using the subset of vehicle data to obtain modeled vehicle data, and compares the estimated vehicle data and the modeled vehicle data to obtain comparison results. Using the comparison results, the processor selects the subset of vehicle data to be sent to the remote server. The one or more servers may be configured to send to respective ones of each of the vehicles other vehicle data for vehicles in a vicinity of that vehicle. The processor at each of the plurality of vehicles may be configured to use the other vehicle data to model at least vehicle location for each of the other vehicles in the vicinity of that vehicle. The one or more servers may be configured to send to respective ones of each of the vehicles local traffic alert information for that vehicle. The system one or more servers may be configured to perform a server-side modeling process for modeling at least vehicle location using the subset of vehicle data to obtain modeled vehicle data, with the client-side modeling process being the same modeling process as the server-side modeling process.

In another aspect, an in-vehicle system is carried by a vehicle for exchanging vehicle location information. One or more navigation sensors or receivers are provided and configured to, at intervals, output sensor information including at least vehicle location information. A processor is provided and configured for performing an estimation process for estimating at sub-intervals at least vehicle location to obtain estimated vehicle data, and for selecting a subset of the vehicle data and sending the subset of vehicle data to a remote server. The processor is configured for performing a client-side modeling process for modeling at least vehicle location using the subset of vehicle data to obtain modeled vehicle data, and for comparing the estimated vehicle data and the modeled vehicle data to obtain comparison results. The processor is configured to use the comparison results to select the subset of vehicle data to be sent to the remote server. A receiver may be provided for receiving from one or more servers other vehicle data for multiple other vehicles. The processor may be configured to use the other vehicle data to model at least vehicle location for each of the other vehicles. The receiver may be configured to receive from the one or more servers local traffic alert information. The one or more servers may be configured to perform a server-side modeling process for modeling at least vehicle location using the subset of vehicle data to obtain modeled vehicle data, with the client-side modeling process using the same model as the server-side modeling process.

### IN THE DRAWINGS

FIG. 1 is block diagram showing the system with one client and one server;

FIG. 2 is block diagram showing server component of the system;

FIG. 3 is block diagram showing the overall system with multiple clients and one server;

### DETAILED DESCRIPTION OF THE PREFERRED EMBODIMENT

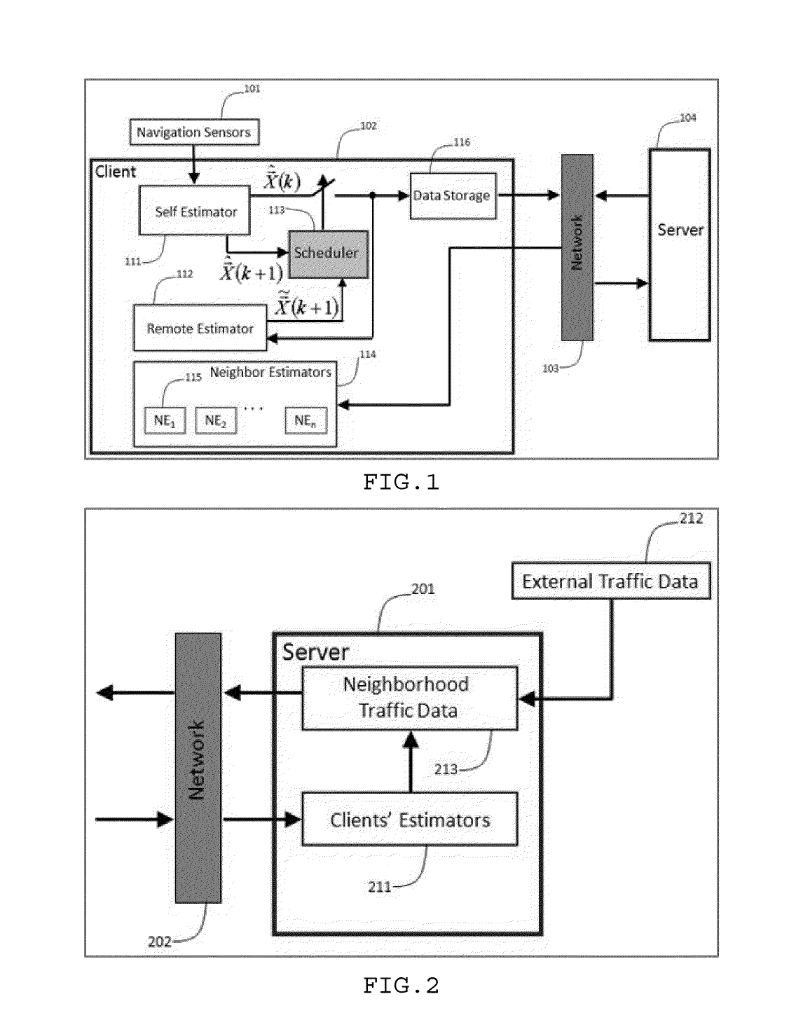

FIG. 1 represents a block diagram embodiment of the present invention, and is referred to herein by the general reference numeral 100. Major components of the system are the Navigation sensors 101, the Client software running on the phone 102, data cellular network 103, and the Server 104.

The Client 102 gets time and location data from the navigation sensors 101 periodically, normally every second. The Navigation sensors include a GPS receiver or equivalent positioning unit; other sensors such as accelerometer, compass, gyro, etc may also be used. Measurements of the Navigation sensors 101 are processed by the Self Estimator 111 to calculate states of self vehicle (SV) at time k and k+1, which k is index of time. Self Estimator 111 estimates position, speed, and heading of the vehicle using an estimation method, like Kalman filtering estimation (wikipedia.org/wiki/Kalman_filter); these quantities collectively constitute the vector {right arrow over (\hat{X} (k), which is the best available estimate of the state of the vehicle at time k. Time difference between k and k+1 is fixed and equal to the time interval between GPS measurements. For the rest of the discussion, we refer to {right arrow over (\hat{X} (k) of the Self Estimator 111 as the state of the vehicle at time k.

The Remote Estimator 112 keeps a copy of the most recent information the Client 102 has stored in the Data Storage 116 regarding its own motion. The Remote Estimator 112 operates first order kinematics model to provide the Scheduler 113 with estimates of SV states at time k+1 given in fact only the information that SV broadcasts to the Server 104 via the Cellular Network 103. The equations for the kinematics model are as follows:

\tilde{X}(k+1)=\tilde{X}(k)+\tilde{V}(k)×cos(\tilde{Φ} (k))×ΔT;

\tilde{Y}(k+1)=\tilde{Y}(k)+\tilde{V}(k)×sin(\tilde{Φ} (k))×ΔT;

\tilde{V}(k+1)=\tilde{V}(k);

\tilde{Φ}(k+1)=\tilde{Φ}(k)+{dot over (\tilde{Φ}(k)×ΔT;

{dot over (\tilde{Φ}(k+1)={dot over (\tilde{Φ}(k);

The state vectors {right arrow over (\hat{X}(.), {right arrow over (\tilde{X}(.) consist of positions X, Y (in the universal GPS coordinate frame with a local origin), speed V, and heading angle Φ. Symbols with (̂ ) on top refer to the Self Estimator's 113 estimates and symbols with (˜) on top refer to the Remote Estimator's 112 estimates.

The Neighbor Estimators 114 receive messages from the Server 104 via the Cellular Network 103. These messages contain the states of the neighborhood traffic, including downstream traffic and/or vehicles that are in the neighborhood of SV. The Neighbor Estimators 114 comprises of several Neighbor Estimators 115, each operating first order kinematics model to provide SV with estimates of states of Neighborhood traffic for times in-between message receptions from the Server 104. We keep the model simple because each vehicle may need to operate many Neighbor Estimators, depending on traffic flow conditions.

Let the Remote Estimator 112 of vehicle i be denoted by REᵢ. Let the Neighbor Estimator 115 run by neighbor j for vehicle i be denoted NEⱼᵢ. The purpose of REᵢ is to estimate the output of all the NEⱼᵢ's.

Whenever SV receives a message, it updates the relevant parameters in the Neighbor Estimators 114 to reflect the values provided in the transmitted message. The outputs of the vehicle Self Estimator 111 and the Neighbor Estimators 114 drive the traffic alert applications.

A vehicle's decision to store the states in the Data Storage 116 at any time instance is made by the Scheduler 113. The Scheduler 113 receives inputs from both the Self Estimator 111 and the Remote Estimator 112. It uses equation below to calculate the longitudinal and lateral position errors. These errors are defined below.

ε_{long.}(k)=|(\tilde{X}(k)−\hat{X}(k))×cos(\hat{Φ}(k))−(\tilde{Y}(k)−Ŷ(k))×sin(\hat{Φ}(k))|

ε_{lat.}(k)=|(\tilde{X}(k)−\hat{X}(k))×sin(\hat{Φ}(k))+(\tilde{Y}(k)−Ŷ(k))×cos(\hat{Φ}(k))|;

At time k, if ε_{long.}(k+1) or ε_{lat.}(k+1) exceed their respective thresholds, SV broadcasts {right arrow over (\hat{X}(k) as specified by the following policy:

u(k)=1

if

(ε_{long.}(k+1)>Tr._{long.} [symbol] ε_{lat.}(k+1)>Tr._{lat.})

u(k)=0 Otherwise

where,
k, is the time index,
u(k), is the scheduler's decision on communication at time k (1 means communication and 0 means no communication)
ε_{long.}(.) is longitudinal tracking position error,
ε_{Lat.}(.) is lateral tracking position error,
Tr._{long.}, is the threshold on the longitudinal error,
Tr._{lat.}, is the threshold on the lateral error.

The two lateral and longitudinal position errors are configured depending on type of the application, for example for Slow Traffic Ahead alert application, values these thresholds may be 10 meters and 100 meters, respectively.

Client 102 periodically or at random times transmits data in the Data Storage 116 to the Server 104. After each data transmission, the Data Storage 116 is cleared, i.e. stored data are erased.

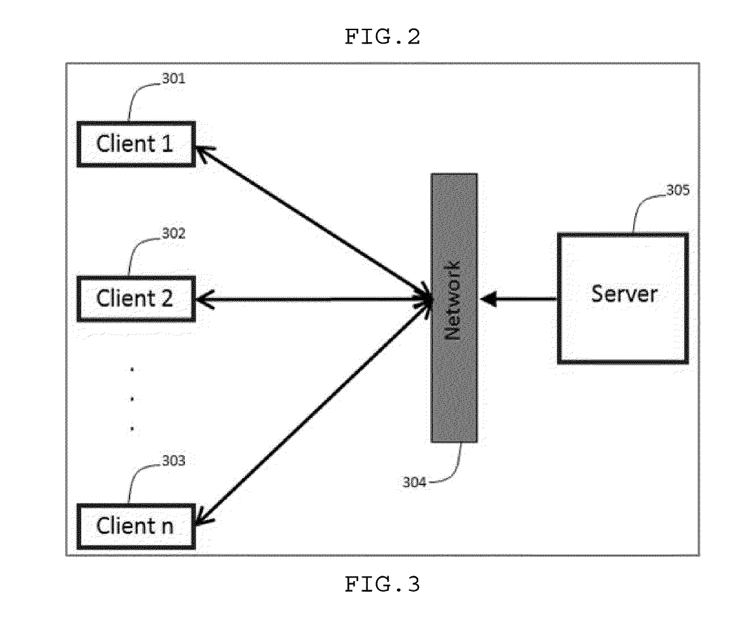

FIG. 2 represents a block diagram embodiment of the present invention for Server component of the system, and is referred to herein by the general reference numeral 200. Major components of the Server 201 are the Clients' Estimators 211, External Traffic Data 212, and Neighborhood Traffic Data 213. The Server 201 receives data from Clients regarding their location, speed, etc data. As explained in first part of this section, these data are selected samples of outputs of the Self Estimators 111. The Clients' Estimator 211 operates the same kinematics model equations that the Remote Estimator 112 does to provide the Neighborhood Traffic Data 213 with estimates of Clients' states at all times. The Neighborhood Traffic Data 213 also receives traffic data from external sources, for example Google Traffic. When a Client transmits data to the Server 201, the Neighborhood Traffic Data 213 sends back to it local traffic information; such as speed of downstream traffic for the next ˜5 kilometers, incident information along route, etc.

FIG. 3 represents a block diagram embodiment of the overall system, and is referred to herein by the general reference numeral 300. As shown in this diagram, at any time “n” number of Clients 301, 302, . . . may exchange data with the Server 305 via the Cellular Network 304.

What is claimed is:

1. A method of exchanging vehicle location information, comprising, at one or more vehicles:
at intervals, inputting sensor information comprising at least vehicle location information;
performing an estimation process for estimating at sub-intervals at least vehicle location to obtain estimated vehicle data;
selecting a subset of the vehicle data and sending the subset of vehicle data to a remote server;
performing a client-side modeling process for modeling at least vehicle location using the subset of vehicle data to obtain modeled vehicle data;
comparing the estimated vehicle data and the modeled vehicle data to obtain comparison results; and
using the comparison results to select the subset of vehicle data to be sent to the remote server.

2. The method of claim 1, comprising receiving at the vehicle from the remote server other vehicle data for a plurality of other vehicles.

3. The method of claim 2, comprising, at the vehicle, using the other vehicle data to model at least vehicle location for each of the plurality of other vehicles.

4. The method of claim 2, comprising receiving at the vehicle from the remote server local traffic alert information.

5. The method of claim 1, comprising performing a server-side modeling process for modeling at least vehicle location using the subset of vehicle data to obtain modeled vehicle data.

6. The method of claim 5, wherein a same model is used by both the client-side modeling process and the server-side modeling process.

7. The method of claim 1, comprising performing the steps of claim 1 at a plurality of different vehicles.

8. A system for exchanging vehicle location information, comprising:
one or more servers;
a communication network; and
a plurality of in-vehicle systems carried by a plurality of vehicles, each in-vehicle system comprising:
one or more navigation sensors or receivers configured to, at intervals, output sensor information comprising at least vehicle location information;
a processor for: performing an estimation process for estimating at sub-intervals at least vehicle location to obtain estimated vehicle data; selecting a subset of the vehicle data and sending the subset of vehicle data to a remote server; performing a client-side modeling process for modeling at least vehicle location using the subset of vehicle data to obtain modeled vehicle data; comparing the estimated vehicle data and the modeled vehicle data to obtain comparison results; and using the comparison results to select the subset of vehicle data to be sent to the remote server.

9. The system of claim 8, wherein the one or more servers are configured to send to respective ones of each of the plurality of vehicles other vehicle data for a plurality of other vehicles in a vicinity of that vehicle.

10. The system of claim 9, wherein the processor at each of the plurality of vehicles is configured to use the other vehicle data to model at least vehicle location for each of the plurality of other vehicles in the vicinity of that vehicle.

11. The system of claim 9, wherein the one or more servers are configured to send to respective ones of each of the plurality of vehicles local traffic alert information for that vehicle.

12. The system of claim 8, wherein the one or more servers are configured to perform a server-side modeling process for modeling at least vehicle location using the subset of vehicle data to obtain modeled vehicle data.

13. The system of claim 12, wherein the client-side modeling process is configured to use a same modeling process as the server-side modeling process.

14. An in-vehicle system carried by a vehicle for exchanging vehicle location information, comprising:
one or more navigation sensors or receivers configured to, at intervals, output sensor information comprising at least vehicle location information; and
a processor for: performing an estimation process for estimating at sub-intervals at least vehicle location to obtain estimated vehicle data; selecting a subset of the vehicle data and sending the subset of vehicle data to a remote server; performing a client-side modeling process for modeling at least vehicle location using the subset of vehicle data to obtain modeled vehicle data; comparing the estimated vehicle data and the modeled vehicle data to obtain comparison results; and using the comparison results to select the subset of vehicle data to be sent to the remote server.

15. The apparatus of claim 14, comprising a receiver for receiving from one or more servers other vehicle data for a plurality of other vehicles.

16. The apparatus of claim 15, wherein the processor is configured to use the other vehicle data to model at least vehicle location for each of the plurality of other vehicles.

17. The apparatus of claim 15, wherein the receiver is configured to receive from the one or more servers local traffic alert information.

18. The apparatus of claim 14, wherein the one or more servers are configured to perform a server-side modeling process for modeling at least vehicle location using the subset of vehicle data to obtain modeled vehicle data, and wherein the client-side modeling process is configured to use a same model as the server-side modeling process.
